(19) United States
(12) Patent Application Publication
(10) Pub. No.: US 2008/0039956 A1
(43) Pub. Date: Feb. 14, 2008

(54) Arrangement of Appliances for Process Control

(75) Inventors: Raiko Milanovic, Heidelberg (DE); Rolf Merte, Heidelberg (DE); Armin Gasch, Speyer (DE); Fabrizio Lorito, I-Mailand (IT); Andrea Moroni, Gorla Minora (IT); Franco Vecchiato, Lipomo (IT); Corrado Bianchi, Lenno (IT); Eugenio Volonterio, Oltrona (IT)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD., Zurich (DE)

(21) Appl. No.: 10/590,650

(22) PCT Filed: Feb. 28, 2004
(86) PCT No.: PCT/EP04/01999

§ 371 Date: Apr. 19, 2007

(51) Int. Cl. G05B 19/00

(52) U.S. Cl. 700/2

(57) ABSTRACT

The invention relates to an arrangement of devices, such as, measuring devices or actuators, which are associated with process technology, and uni-directional or bidirectional data exchange with a central point, such as a control center or display device. A transmitting/receiving device is arranged such that data can be exchanged with the central point. The transmitting/receiving device is also arranged such that data from the other devices can be retrieved or transmitted further. The other devices do not comprise a transmitting or receiving device for direct communication with the central point.

The invention relates to an arrangement of appliances with an information output. Appliances such as these are, for example, sensors or measurement devices which emit measurement values, or actuators which emit state data, in which case the output information can be passed on to another point.

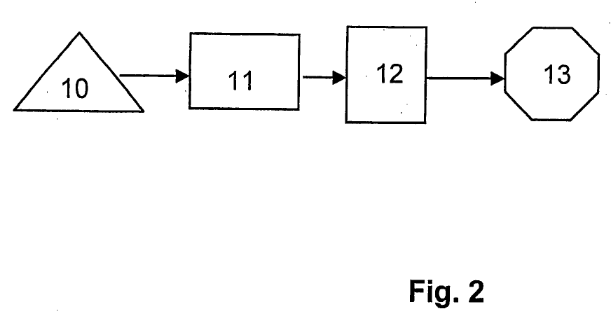

FIG. 2 shows one known typical arrangement. This shows a measurement arrangement in which a first element is the actual sensor 10 which is subject to the physical influence. A second element is an information transducer 11 which produces an analog or digital image of the physical effect. A transmitter 12 is used as a third element, and is required when transmission to a display 13 is intended. In an arrangement such as this, this results in a one-to-one association of the respective function with a detecting, processing, transmitting and display element. If a plurality of measurement arrangements are associated with one technical process, then at least the sensor 10, information transducer 11 and transmitter 12 are in each case required.

This also applies to active elements such as actuators, which pass on information relating to their state or activity. For example, a valve regulator signals either the “open” state or the “closed” state, and, in the case of a control valve, the incremental position change is also signaled.

Since all the components for each measurement point and each actuator in a process control system are used to record, process and pass on measurement values, this results in unnecessary redundancy. Production costs and complexity could be reduced if only the actually required components were included.

The invention is thus based on the object of specifying an arrangement which results in a reduction in the overall complexity.

This object is achieved by an appliance arrangement which has the features specified in claim 1. Advantageous refinements are specified in further claims.

The invention accordingly proposes that the hardware complexity in an arrangement of instruments or actuators which are associated with a technical process and require data interchange with a central point be reduced by not allocating a transmitter or a transmitting/receiving state to all of these appliances, but by using only one jointly used transmitting/receiving device. In addition to the saving, the arrangement has the advantage that it provides a capability for information preprocessing, plausibility checking and diagnosis.

The invention and its advantages will be described further in the following text with reference to one exemplary embodiment, which is illustrated in the drawing figures, in which:

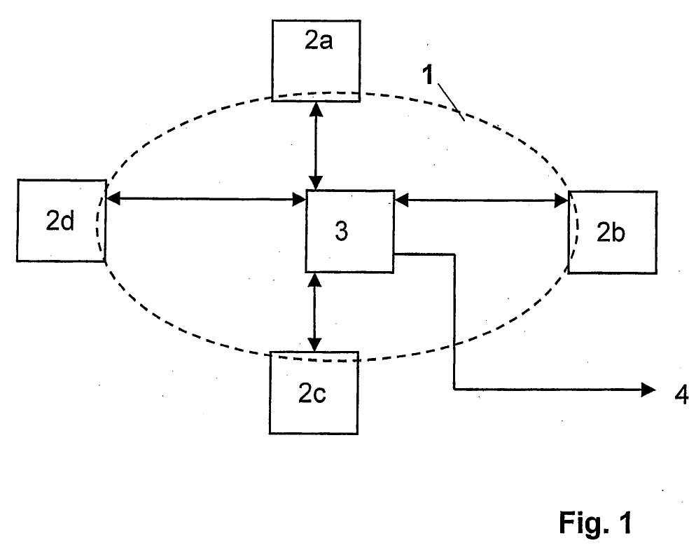

FIG. 1 shows an appliance arrangement according to the invention, and

FIG. 2 shows an arrangement according to the prior art.

FIG. 1 shows an arrangement of appliances 2a, 2b, 2c and 2d, which are associated with a technical process 1 for open-loop and closed-loop control. The appliances 2a, 2b, 2c, 2d are, for example, instruments or actuators, but in any case appliances which require communication with a central point 4. In contrast to the arrangement shown in FIG. 2, the appliances 2a, 2b, 2c, 2d do not, however, have any means for direct communication with the central point 4. A transmitter/receiver 3 is provided for communication with the central point 4, and can be associated with one of the appliances 2a, 2b, 2c, 2d. With regard to processing performance, memory capacity and transmission bandwidth, the transmitter/receiver 3 is designed to handle all the amounts of data which occur from all of the appliances 2a, 2b, 2c, 2d. The central point 4 may, for example, be a process control console, or its control station.

The transmitter/receiver 3 is connected to all of the appliances 2a, 2b, 2c, 2d and is designed to read the data from them either simultaneously or successively, to digitize the data if required, and to transmit it to the central point 4 using a suitable transmission protocol.

Since, in addition to instruments, actuators can also be connected to the transmitter/receiver 3, plausibility checks and diagnoses can be carried out without connection to a central point, in addition to preprocessing of so-called raw data. By way of example, a valve regulator can thus pass on information relating to the valve position to adjacent flowmeters, which themselves signal back whether the “valve closed” signal also actually results in “zero” flow.

The expressions “transmitter”, transmitter/receiver” as well as “send” as used above generally represent a “transmission unit” or “transmission”, that is to say they are used both for wire-free and wire-based data interchange. Examples of this are fieldbus systems, Ethernet or the HART protocol.

1. An arrangement of appliances such as instruments or actuators which are associated with a technical process, and a unidirectional or bidirectional data interchange with a central point, such as a control console or display device, wherein
a) a transmitter/receiver is arranged, which is designed for data interchange with the central point,
b) the transmitter/receiver is also designed to call up data from the other appliances or to pass data to them, with the other appliances not having any transmitting or receiving device for direct communication with the central point.

2. The arrangement as claimed in claim 1, wherein the transmitter/receiver is associated with one of the appliances.

3. The arrangement as claimed in claim 1, wherein the appliances are designed to interchange data with one another by means of the transmitter/receiver, and to carry out data preprocessing and/or diagnosis functions.

4. The arrangement as claimed in claim 1, wherein the appliances are designed to pass on their data as an analog signal or as a digital signal.

5. The arrangement as claimed in claim 1, wherein the transmitter/receiver is designed to carry out analog/digital signal conversion, and/or data preprocessing.

6. The arrangement as claimed in claim 2, wherein the appliances are designed to interchange data with one another by means of the transmitter/receiver, and to carry out data preprocessing and/or diagnosis functions.

7. The arrangement as claimed in claim 6, wherein the appliances are designed to pass on their data as an analog signal or as a digital signal.

8. The arrangement as claimed in claim 7, wherein the transmitter/receiver is designed to carry out analog/digital signal conversion, and/or data preprocessing.

9. System comprising:
an arrangement of appliances, each of which functions as at least one of a measuring device and an actuator;
a central communication device for data interchange; and
a transmitter/receiver arranged for data interchange with the central communication device, and configured for bidirectional communication with the appliances, wherein the system is not configured for the appliances to transmit or receive direct communications with the central communication device.
